(19) United States
(12) Patent Application Publication
(10) Pub. No.: US 2025/0314774 A1
(43) Pub. Date: Oct. 9, 2025

(54) METHOD FOR CORRECTING IMAGE FRAME OF LIDAR DEVICE AND LIDAR DEVICE

(71) Applicant: HL Klemove Corp., Incheon (KR)

(72) Inventor: Kimoon KANG, Incheon (KR)

(73) Assignee: HL Klemove Corp., Incheon (KR)

(21) Appl. No.: 18/958,373

(22) Filed: Nov. 25, 2024

(30) Foreign Application Priority Data
Apr. 3, 2024 (KR) 10-2024-0045381

(51) Int. Cl. G01S 17/89; G01S 7/481; G06T 7/73

(52) U.S. Cl. CPC G01S 17/89; G01S 7/4817; G06T 7/74; G06T 2207/10028; G06T 2207/20021

(57) ABSTRACT

A method for correcting an image frame of a LiDAR device and a LiDAR device are disclosed. The method may include: receiving a correction target partition including some pixels in a correction target image frame; extracting a plurality of comparison target partitions, which are composed of some pixels within a reference image frame, to be compared with the correction target partition; extracting a maximum correlation partition having the highest correlation with the correction target partition among the plurality of comparison target partitions; and calculating a field of view offset of the correction target partition using information of the maximum correlation partition.

### CROSS-REFERENCE TO RELATED APPLICATION

This application claims priority to and benefit from Korean Patent Application No. 10-2024-0045381, filed on Apr. 3, 2024, the disclosures of which are incorporated herein by reference in its entirety.

### TECHNICAL FIELD

The present disclosure relates to a method for correcting an image frame of a LiDAR device and a LiDAR device, and more particularly, to a method for correcting an image frame of a LiDAR device and a LiDAR device for ensuring consistency in the field of view of the image frame of the LiDAR device.

### RELATED ART

The scanning type LiDAR device expands the field of view (FoV) through a scanner that has reflection mirrors on a plurality of surfaces that reflect laser light transmitted by an optical transmitter to the outside or reflect laser light reflected from the outside to an optical receiver and operates so that the plurality of surfaces rotate around an axis.

This scanning type LiDAR device has a problem in that the field of view is different for each image frame or the entire image frame is shaken during the data acquisition process. Due to this, the image is distorted, and an error may occur in the recognition of the object. To solve this problem, correction needs to be performed so that all image frames output by the scanning LiDAR device have a consistent field of view.

### SUMMARY

The present disclosure aims to solve the above problems, and the present disclosure is directed to providing a method for correcting an image frame of a LiDAR device for allowing all image frames output by a scanning type LiDAR device to have a consistent field of view and a LiDAR device for outputting an image frame corrected according to the correction method.

The objects of the present disclosure are not limited to the above-described objects, and other objects that are not mentioned will be able to be clearly understood by those skilled in the art to which the present disclosure pertains from the following description.

According to an aspect of the present disclosure, provided is a method for correcting an image frame of a LiDAR device that corrects an image frame generated by a LiDAR device having a scanner that has reflection mirrors on a plurality of surfaces that reflect laser light transmitted by an optical transmitter to the outside or reflect laser light reflected from the outside to an optical receiver and operates so that the plurality of surfaces rotate around an axis, the method including: receiving a correction target partition including some pixels in a correction target image frame; extracting a plurality of comparison target partitions, which are composed of some pixels within a reference image frame, to be compared with the correction target partition; extracting a maximum correlation partition having the highest correlation with the correction target partition among the plurality of comparison target partitions; and calculating a field of view offset of the correction target partition using information of the maximum correlation partition.

In the method for correcting an image frame of a LiDAR device according to an aspect of the present disclosure, in the correction target image frame, a plurality of said correction target partitions may be extracted throughout the entire correction target image frame without overlapping each other.

In the method for correcting an image frame of a LiDAR device according to an aspect of the present disclosure, the correction target partition may divide the correction target image frame into a plurality of parts along the horizontal direction.

In the method for correcting an image frame of a LiDAR device according to an aspect of the present disclosure, the extracting a plurality of comparison target partitions may include extracting a reference comparison target partition composed of pixels in a region corresponding to the correction target partition within the reference image frame; and extracting one or more shift lag comparison target partitions having the same size as the reference comparison target partition and composed of pixels in a region shifted to the left or right at a predetermined interval based on the reference comparison target partition, wherein the plurality of comparison target partitions include the reference comparison target partition and one or more shift lag comparison target partitions.

In the method for correcting an image frame of a LiDAR device according to an aspect of the present disclosure, in the extracting one or more shift lag comparison target partitions, an equal number of the one or more shift lag comparison target partitions may be extracted on the left and right sides, respectively, based on the reference comparison target partition.

In the method for correcting an image frame of a LiDAR device according to an aspect of the present disclosure, the reference image frame and the correction target image frame may include a plurality of pixels with each pixel constituting one vertical column in the correction target image frame or the reference image frame, and in the extracting one or more shift lag comparison target partitions, the predetermined interval may be set to a size corresponding to the one pixel.

In the method for correcting an image frame of a LiDAR device according to an aspect of the present disclosure, the extracting a maximum correlation partition may include calculating a correlation coefficient between each of the plurality of comparison target partitions and the correction target partition; and selecting a comparison target partition having a maximum correlation coefficient among the plurality of comparison target partitions as the maximum correlation partition.

In the method for correcting an image frame of a LiDAR device according to an aspect of the present disclosure, the correction target image frame or the reference image frame may be formed by arranging individual pixels, with each pixel constituting one vertical column, side by side in the horizontal direction within the correction target image frame or the reference image frame, and the individual pixels may contain multiple pieces of channel-specific signal strength information that constitute one horizontal row within the correction target image frame or the reference image frame.

In the method for correcting an image frame of a LiDAR device according to an aspect of the present disclosure, in the calculating a correlation coefficient, the correlation coefficient may be calculated by comparing all signal strength information included in the comparison target partition with all signal strength information included in the correction target partition.

In the method for correcting an image frame of a LiDAR device according to an aspect of the present disclosure, in the calculating a correlation coefficient, the correlation coefficient may be determined as a correlation coefficient between a vector including all signal strength information included in the comparison target partition and a vector including all signal strength information included in the correction target partition.

In the method for correcting an image frame of a LiDAR device according to an aspect of the present disclosure, at least some of the pixels may include signal strength information estimated and determined through interpolation.

In the method for correcting an image frame of a LiDAR device according to an aspect of the present disclosure, an interpolation rate of the interpolation may be determined to correspond to a horizontal angular resolution of the LiDAR device.

In the method for correcting an image frame of a LiDAR device according to an aspect of the present disclosure, the channel-specific signal strength information may be allocated through the interpolation to all available pixels to the correction target image frame or the reference image frame.

In the method for correcting an image frame of a LiDAR device according to an aspect of the present disclosure, the field of view offset may be determined by multiplying the maximum correlation coefficient by a horizontal angular resolution of the LiDAR device.

The method for correcting an image frame of a LiDAR device according to an aspect of the present disclosure may further include moving the position of the correction target partition by a calculated field of view offset within the correction target image frame.

According to another aspect of the present disclosure, provided is a LiDAR device, including: an optical transmitter configured to transmit laser light; an optical receiver configured to receive laser light transmitted by the optical transmitter and reflected from the outside; a scanner that has reflection mirrors on a plurality of surfaces that reflect laser light transmitted by the optical transmitter to the outside or reflect laser light reflected from the outside to the optical receiver and operates so that the plurality of surfaces rotate around an axis; and a controller configured to detect laser light received by the optical receiver and generate image information, wherein the controller stores one or more field of view offsets calculated according to the method for correcting an image frame of a LiDAR device.

In the LiDAR device according to another aspect of the present disclosure, the controller may generate a plurality of image frames corresponding to the number of surfaces provided with the reflection mirror during one rotation of the scanner, and store the field of view offset for the plurality of image frames.

In the LiDAR device according to another aspect of the present disclosure, the field of view offset may be allocated, based on an image frame set as the reference image frame among the plurality of image frames, for each of the remaining correction target image frames except for the image frame set as the reference image frame among the plurality of image frames.

In the LiDAR device according to another aspect of the present disclosure, the correction target image frame may include a plurality of partitions extracted throughout the entire correction target image frame without overlapping each other, and the field of view offset is allocated for each of the plurality of partitions. In the LiDAR device according to another aspect of the present disclosure, the controller may output each of the image frames by reflecting the field of view offset when outputting each of the image frames.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a flowchart of a method for correcting an image frame of a LiDAR device according to an exemplary embodiment of the present disclosure;

FIG. 2 is a diagram illustrating a configuration and operation of a scanning type LiDAR device;

FIG. 3 is a diagram exemplarily illustrating that distortion of the field of view occurs on a reflective surface of a scanner of a scanning type LiDAR;

FIG. 4 is a diagram illustrating an example of a reference image frame and a correction target image frame used in a method for correcting an image frame of a LiDAR device according to an exemplary embodiment of the present disclosure.

FIG. 5 is a detailed flowchart illustrating a step of extracting a plurality of comparison target partitions in a method for correcting an image frame of a LiDAR device according to an exemplary embodiment of the present disclosure;

FIG. 6 is a diagram exemplarily illustrating a plurality of comparison target partitions used in a method for correcting an image frame of a LiDAR device according to an exemplary embodiment of the present disclosure;

FIG. 7 is a detailed flowchart illustrating a step of extracting a maximum correlation partition in a method for correcting an image frame of a LiDAR device according to an exemplary embodiment of the present disclosure;

FIG. 8 is a diagram illustrating a concept of pixel interpolation in an image frame of a LiDAR device; and

FIG. 9 is a diagram illustrating a configuration of a LiDAR device according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

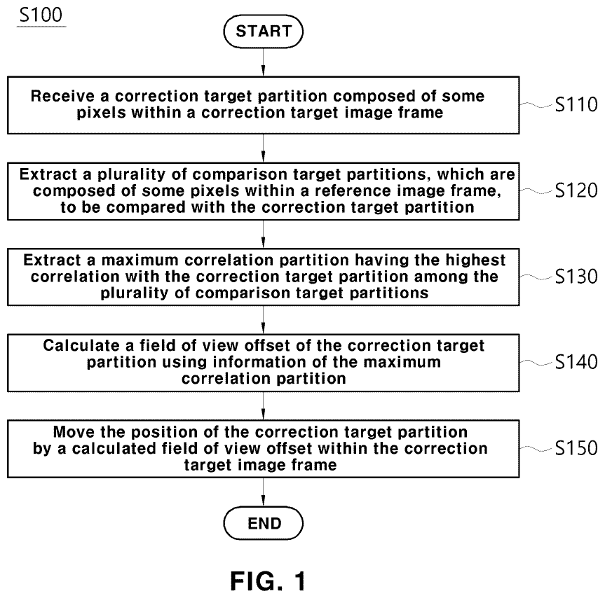

FIG. 1 is a flowchart of a method for correcting an image frame of a LiDAR device according to an exemplary embodiment of the present disclosure.

A method S100 for correcting an image frame of a LiDAR device according to an exemplary embodiment of the present disclosure improves the consistency of the field of view of an image frame output from a LiDAR device. In more detail, the method S100 for correcting an image frame of a LiDAR device according to an exemplary embodiment of the present disclosure may correct an image frame generated by a LiDAR device including a scanner that has reflection mirrors on a plurality of surfaces that reflect laser light transmitted by an optical transmitter to the outside or reflect laser light reflected from the outside to an optical receiver and operates so that the plurality of surfaces rotate around an axis.

The method S100 for correcting an image frame of a LiDAR device according to an exemplary embodiment of the present disclosure may be performed by a computing device. For example, the computing device may include a memory and a processor.

The memory stores one or more instructions. In addition, the processor may perform the one or more instructions. In other words, the method S100 for correcting an image frame of a LiDAR device may be performed by the processor performing the one or more instructions.

The memory may include a hardware device configured to store and perform program instructions. For example, the memory may include a storage medium such as a ROM, a RAM, and a flash memory. In addition, the memory may include a magnetic medium such as a floppy disk and a magnetic tape; an optical medium such as a compact disk read only memory (CD-ROM) and a digital video disk (DVD); a magneto-optical medium such as a floptical disk, a read-only memory; and the like.

The processor executes the one or more instructions. For example, the processor may be a hardware unit that performs calculation and control in a computer. The processor may include at least one arithmetic logic unit (ALU) and a register.

Referring to FIG. 1, the method S100 for correcting an image frame of a LiDAR device according to an exemplary embodiment of the present disclosure may be performed as follows.

First, a correction target partition, which is composed of some pixels within a correction target image frame, is received (S110).

The configuration and operation of the scanning type LiDAR device in relation to the correction target image frame will be briefly described.

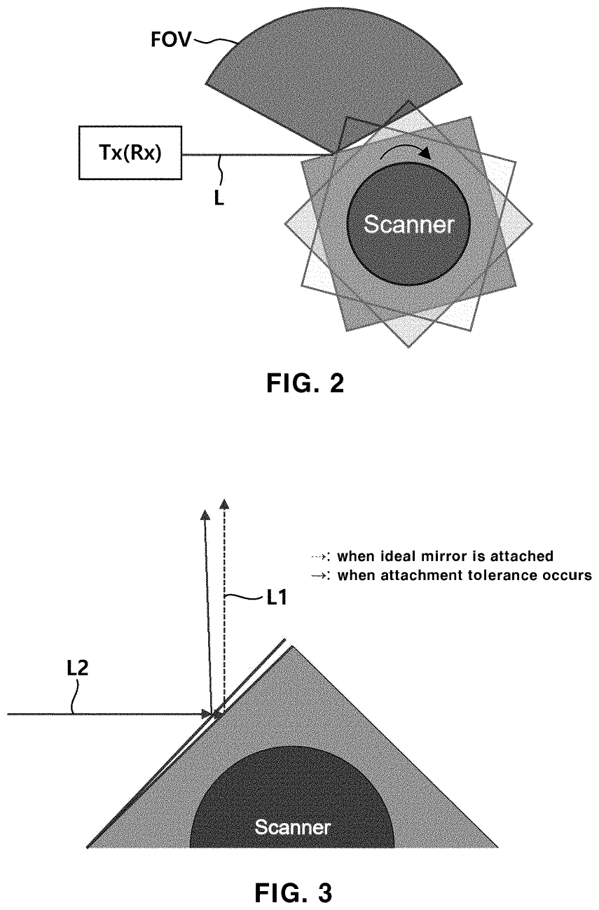

FIG. 2 is a diagram illustrating a configuration and operation of a scanning type LiDAR device. FIG. 3 is a diagram exemplarily illustrating that distortion of the field of view occurs on a reflective surface of a scanner of a scanning type LiDAR.

Referring to FIGS. 2 and 3, the scanning type LiDAR device includes an optical transmitter Tx that transmits laser light L, an optical receiver Rx that receives laser light L reflected from the outside, and a scanner that has reflection mirrors on a plurality of surfaces that reflect laser light L transmitted by the optical transmitter Tx to the outside or reflect laser light L reflected from the outside to the optical receiver Rx and operates so that the plurality of surfaces rotate around an axis.

The scanner reflects laser light L while rotating. Accordingly, the LiDAR device may secure a wide range of field of view (FoV).

Meanwhile, one image frame may be constructed using laser light reflected by one reflection mirror. Accordingly, a plurality of image frames may be secured during one rotation of the scanner.

For example, the scanner may have four surfaces, and a first reflection mirror M1, a second reflection mirror M2, a third reflection mirror M3, and a fourth reflection mirror M4 may be provided on the surfaces, respectively. In this case, four image frames may be acquired during one rotation of the scanner.

When scanning is performed through a plurality of reflective mirrors provided on a plurality of surfaces as described above, each of the reflection mirrors may have different fields of view. This may occur due to the attachment tolerance of the reflection mirror M as shown in FIG. 3. In addition, the above problem may occur due to a decenter in which the system origin of the LiDAR device and the origin of the scanner do not match each other.

The correction target image frame may be defined as image frames obtained through the reflection mirror provided on the other surfaces of the plurality of surfaces provided in the scanner of the scanning type LiDAR device, assuming that the image frame obtained through the reflection mirror provided on any one of the plurality of surfaces provided in the scanner is determined as the reference image frame. For example, the reference frame may be set as an image frame obtained by a reflection mirror having the least attachment tolerance.

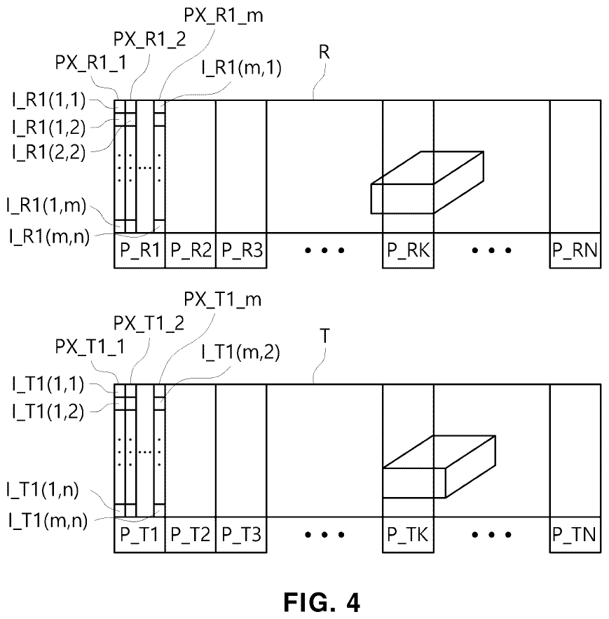

FIG. 4 is a diagram illustrating an example of a reference image frame and a correction target image frame used in a method for correcting an image frame of a LiDAR device according to an exemplary embodiment of the present disclosure.

Referring to FIG. 4, it may be confirmed that the position in the correction target frame T of the object O shown in the correction target image frame T does not match the position in the correction target frame T of the object O shown in the reference image frame R. This is caused by the lack of consistency of field of view between the correction target image frame T and the reference image frame R.

The correction target frame T may include a plurality of correction target partitions composed of some pixels in the correction target frame T.

Here, the pixel may be defined as a unit constituting one vertical column in the correction target frame (T) frame. In addition, one pixel may store channel-specific signal strength information for a plurality of channels allocated along the vertical direction.

In the correction target image frame T, a plurality of correction target partitions may be extracted throughout the entire correction target image frame T without overlapping each other. In addition, the correction target partition may divide the correction target image frame T into a plurality of parts along the horizontal direction.

For example, a first correction target partition P_T1 consisting of a first pixel PX_T1_1 and a second pixel PX_T1_2 to an mth pixel PX_T1_m (m is a natural number of 2 or more) arranged in succession with each other of the correction target frame T, a second correction target partition P_T2 covering the entire correction target frame T without overlapping each other, a Kth correction target partition P_TK (K is an arbitrary natural number of 2 or more), and an Nth correction target partition P_TK (N is a natural number of K or more) may be included.

Meanwhile, the first pixel PX_T1_1 includes n (n is a natural number of 2 or more) pieces of channel-specific signal strength information I_T1(1, 1), I_T1(1, 2), and I_T1(1, n) allocated in the vertical direction. The second pixel PX_T1_2 to the mth pixel PX_T1_m also includes channel-specific signal strength information.

Pixels included in each correction target partition do not overlap each other. That is, one pixel is allocated to one correction target partition.

By dividing and the correction target image frame T into a plurality of correction target partitions and comparing them with the reference target image frame R without comparing the correction target image frame T with the reference target image frame R as a whole (whole to whole), a field of view offset to be described later may be calculated for each of the plurality of correction target partitions. Accordingly, the accuracy of correction may be improved.

Next, a plurality of comparison target partitions, which are composed of some pixels in a reference image frame, to be compared with the correction target partition, are extracted (S120).

Referring to FIG. 4, the reference image frame R may have partitions corresponding to the correction target partition. In this case, a partition composed of pixels in a region corresponding to the correction target partition in the reference image frame R may be defined as a reference comparison target partition.

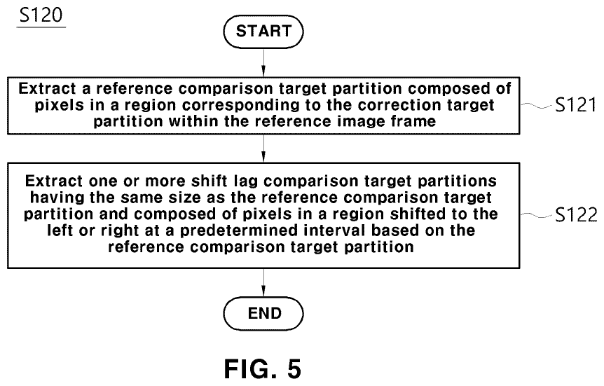

FIG. 5 is a detailed flowchart illustrating a step of extracting a plurality of comparison target partitions in a method for correcting an image frame of a LiDAR device according to an exemplary embodiment of the present disclosure.

Referring to FIG. 5, the step S120 of extracting a plurality of comparison target partitions may be performed as follows.

First, a reference comparison target partition composed of pixels in a region corresponding to the correction target partition in the reference image frame is extracted (S121).

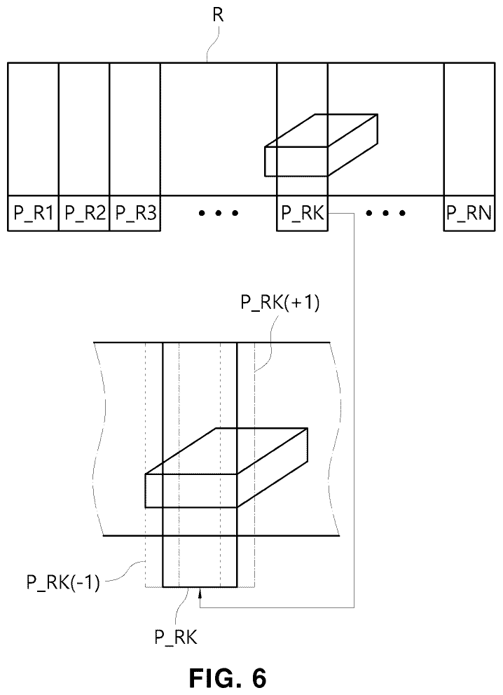

FIG. 6 is a diagram exemplarily illustrating a plurality of comparison target partitions used in a method for correcting an image frame of a LiDAR device according to an exemplary embodiment of the present disclosure.

Referring to FIG. 6, when the correction target partition selected in the correction target image frame T is the Kth correction target partition P_TK, the Kth reference comparison target partition P_RK composed of pixels in the corresponding region in the reference image frame R may be extracted as the reference comparison target partition.

Next, one or more shift lag comparison target partitions having the same size as the reference comparison target partition and composed of pixels in a region shifted to the left or right at a predetermined interval based on the reference comparison target partition are extracted (S122).

An equal number of the one or more shift lag comparison target partitions may be extracted on the left and right sides, respectively, based on the reference comparison target partition.

Referring to FIG. 6, when the Kth reference comparison target partition P_RK is extracted as the reference comparison target partition in the reference image frame R, the K−1 shift lag comparison target partition P_RK(−1) shifted to the left by a predetermined interval and the K+1 shift lag comparison target partition P_RK(+1) shifted to the right by a predetermined interval may be extracted as shift lag comparison target partitions.

Meanwhile, as described above, the reference image frame R and the correction target image frame T include a plurality of pixels with each pixel constituting one vertical column. In this regard, in the step S122 of extracting one or more shift lag comparison target partitions, the predetermined interval may be set to a size corresponding to the one pixel.

In this way, when comparison target partitions are extracted, the plurality of comparison target partitions may include the reference comparison target partition and one or more shift lag comparison target partitions.

Next, after the step S120 of extracting a plurality of comparison target partitions, a maximum correlation partition having the highest correlation with the correction target partition among the plurality of comparison target partitions is extracted (S130).

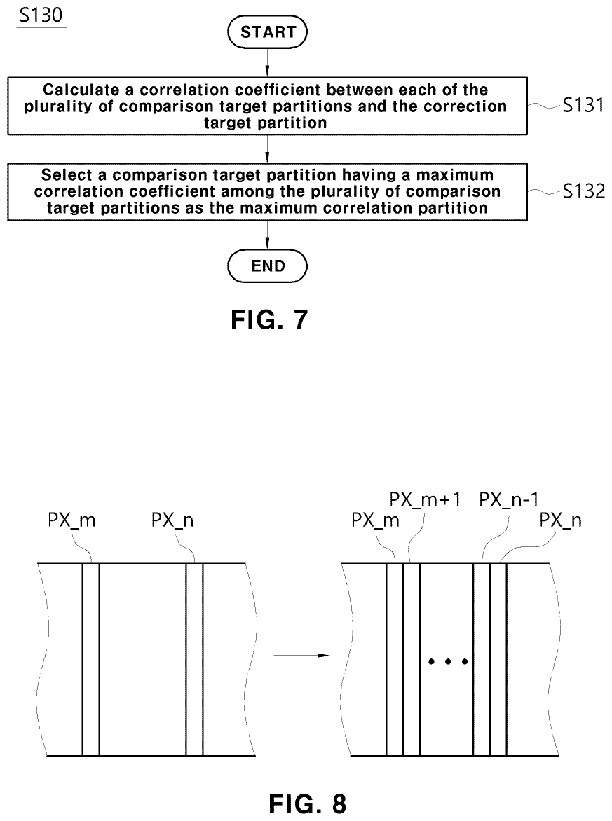

FIG. 7 is a detailed flowchart illustrating a step of extracting a maximum correlation partition in a method for correcting an image frame of a LiDAR device according to an exemplary embodiment of the present disclosure.

Referring to FIG. 7, the step S130 of extracting a maximum correlation partition may be performed as follows.

First, a correlation coefficient between each of the plurality of comparison target partitions and the correction target partition is calculated (S131).

Subsequently, a comparison target partition having a maximum correlation coefficient among the plurality of comparison target partitions is selected as the maximum correlation partition (S132).

As discussed above, the correction target image frame T or the reference image frame R is formed by arranging individual pixels, with each pixel constituting one vertical column, side by side in the horizontal direction. In addition, the individual pixels contain multiple pieces of channel-specific signal strength information that constitute one horizontal row within the correction target image frame T or reference image frame R.

In the step S131 of calculating a correlation coefficient, the correlation coefficient may be calculated by comparing all signal strength information included in the comparison target partition with all signal strength information included in the correction target partition.

In more detail, the correlation coefficient may be determined as a correlation coefficient between a vector including all signal strength information included in the comparison target partition and a vector including all signal strength information included in the correction target partition.

Next, after the step S130 of extracting a maximum correlation partition, a field of view offset of the correction target partition is calculated using the information of the maximum correlation partition (S140).

The field of view offset may be determined by multiplying the maximum correlation coefficient by a horizontal angular resolution of the LiDAR device. Here, the horizontal angular resolution corresponds to an interval between pixels adjacent to each other in the reference image frame R or the correction target image frame T. For example, the interval between pixels adjacent to each other in the reference image frame R or the correction target image frame T corresponds to a unit angle at the field of view, and the unit angle may be the horizontal angular resolution of the LiDAR device.

In this regard, at least some of the pixels may include signal strength information estimated and determined through interpolation.

FIG. 8 is a diagram illustrating a concept of pixel interpolation in an image frame of a LiDAR device.

Referring to FIG. 8, in general, a LiDAR device does not output an image frame according to a maximum horizontal angular resolution designed to increase the efficiency of device operation, but rather outputs by decreasing the horizontal angular resolution. Accordingly, not all pixels in the image frame output signal strength information, but only a part of all pixels output signal strength information.

For example, as shown on the left side of FIG. 8, the mth (m is a natural number) pixel PX_m outputs signal strength information in the image frame, and the nth (n is a natural number greater than m) pixel PX_n spaced apart from this by a predetermined interval outputs signal strength information, but the pixels between the mth pixel PX_m and the nth pixel PX_n do not output signal strength information.

If the design maximum horizontal angular resolution of the LiDAR device is 0.01°, and the interval between adjacent pixels corresponds to the field of view of 0.01°, when the LiDAR device outputs the horizontal angular resolution at 0.05°, not all pixels in the image frame output signal strength information, but only 1/5 of all pixels output signal strength information.

In this case, the accuracy of calculation and correction of the offset angle of the field of view is lowered. According to an exemplary embodiment of the present disclosure, interpolation may be performed to solve this problem.

In other words, if only some of the pixels rather than all pixels in the image frame output signal strength information, the signal strength information of pixels placed between pixels outputting signal strength can be determined through interpolation, assigned to the pixels, and used for correction.

For example, as shown on the left side of FIG. 8, if the mth pixel PX_m and the nth pixel PX_n output signal strength information in the image frame, but the pixels between the mth pixel PX_m and the nth pixel PX_n do not output signal strength information, as shown on the right side of FIG. 8, when the method S100 for correcting an image frame of a LiDAR device according to an exemplary embodiment of the present disclosure is performed after allocating signal strength information to pixels PX_m+1, . . . , PX_n−1 between the mth pixel and the nth pixel through interpolation, the accuracy of correction may be improved.

An interpolation rate of the interpolation may be determined to correspond to a horizontal angular resolution of the LiDAR device. In this case, the channel-specific signal strength information may be allocated through the interpolation to all available pixels to the correction target image frame T or the reference image frame R.

Finally, after the step S140 of calculating a field of view offset of the correction target partition, the position of the correction target partition in the correction target image frame is moved by a calculated field of view offset (S150).

Consistency of field of view between image frames may be improved by moving the position of the correction target partition by a calculated field of view offset within the correction target image frame.

Referring to FIG. 6, the Kth correction target partition P_TK has the highest correlation with the K−1 shift lag comparison target partition P_RK(−1) which is obtained by shifting the Kth reference comparison target partition P_RK to the left by a predetermined interval. Accordingly, the K−1 shift lag comparison target partition P_RK(−1) is extracted as the maximum correlation partition of the Kth correction target partition P_TK.

In this case, the field of view offset of the Kth correction target partition P_TK may be determined as an interval between adjacent pixels. Based on this field of view offset information, the position of the Kth correction target partition P_TK in the correction target image frame T may be shifted (moved) to the left by one pixel interval.

The method S100 for correcting an image frame of a LiDAR device according to an exemplary embodiment of the present disclosure has been described above in detail. Hereinafter, a LiDAR device 10 according to an exemplary embodiment of the present disclosure will be described in detail.

The LiDAR device 10 according to an exemplary embodiment of the present disclosure is configured to have a correction according to the method S100 for correcting an image frame of a LiDAR device according to an exemplary embodiment of the present disclosure, and has a feature in which a field of view of each image frame is consistent.

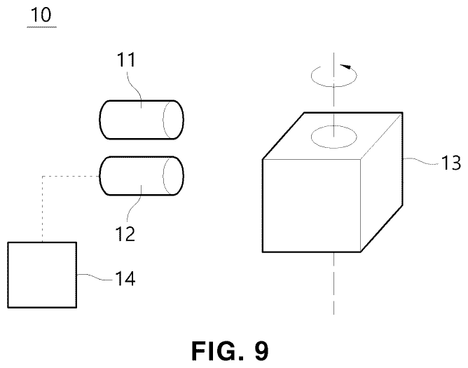

FIG. 9 is a diagram illustrating a configuration of a LiDAR device according to an exemplary embodiment of the present disclosure.

Referring to FIG. 9, the LiDAR device 10 according to an exemplary embodiment of the present disclosure may include an optical transmitter 11, an optical receiver 12, a scanner 13, and a controller 14.

The optical transmitter 11 transmits laser light. In addition, the optical receiver 12 receives laser light transmitted by the optical transmitter 11 and reflected from the outside.

The scanner 13 has reflection mirrors M1, M2, M3, and M4 on a plurality of surfaces that reflect laser light transmitted by the optical transmitter 11 to the outside or reflect laser light reflected from the outside to the optical receiver 12 and operates so that the plurality of surfaces rotate around an axis.

For example, the scanner 13 may have four surfaces, and have a first reflection mirror M1, a second reflection mirror M2, a third reflection mirror M3, and a fourth reflection mirror M4. When the scanner 13 rotates one time, four image frames may be acquired.

The controller 14 detects the laser light received by the optical receiver 12 and generates image information. The controller 14 stores one or more field of view offsets calculated according to the method S100 for correcting an image frame of a LiDAR device according to an exemplary embodiment of the present disclosure.

The controller 14 may generate a plurality of image frames corresponding to the number of surfaces provided with the reflection mirror during one rotation of the scanner 13, and may store the field of view offset for the plurality of image frames.

The field of view offset may be allocated, based on an image frame set as the reference image frame among the plurality of image frames, for each of the remaining correction target image frames except for the image frame set as the reference image frame among the plurality of image frames.

In this case, the correction target image frame may include a plurality of partitions extracted throughout the entire correction target image frame without overlapping each other, and the field of view offset may be allocated for each of the plurality of partitions.

The controller 14 may output each of the image frames by reflecting the field of view offset when outputting each of the image frames. Thus, the LiDAR device 10 according to an exemplary embodiment of the present disclosure may output a plurality of image frames in a consistent field of view.

According to the above configuration, the method for correcting an image frame of a LiDAR device according to an aspect of the present disclosure improves the field of view consistency of the image frame of the LiDAR device by calculating a field of view offset of the correction target partition of the correction target image frame using a plurality of comparison target partitions selected from the reference image frame, and the LiDAR device according to the present disclosure that stores a field of view offset calculated according to the method for correcting an image frame of a LiDAR device outputs an image frame having a consistent field of view.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A method for correcting an image frame of a LiDAR device, the method comprising:
receiving a correction target partition including some pixels in a correction target image frame;
extracting a plurality of comparison target partitions, which are composed of some pixels within a reference image frame, to be compared with the correction target partition;
extracting a maximum correlation partition having the highest correlation with the correction target partition among the plurality of comparison target partitions; and
calculating a field of view offset of the correction target partition using information of the maximum correlation partition.

2. The method of claim 1, wherein in the correction target image frame, a plurality of said correction target partitions are extracted throughout the entire correction target image frame without overlapping each other.

3. The method of claim 1, wherein the correction target partition divides the correction target image frame into a plurality of parts along the horizontal direction.

4. The method of claim 1,
wherein the extracting a plurality of comparison target partitions comprises:
extracting a reference comparison target partition composed of pixels in a region corresponding to the correction target partition within the reference image frame; and
extracting one or more shift lag comparison target partitions having the same size as the reference comparison target partition and composed of pixels in a region shifted to the left or right at a predetermined interval based on the reference comparison target partition,
wherein the plurality of comparison target partitions comprise the reference comparison target partition and one or more shift lag comparison target partitions.

5. The method of claim 4, wherein in the extracting one or more shift lag comparison target partitions, an equal number of the one or more shift lag comparison target partitions is extracted on the left and right sides, respectively, based on the reference comparison target partition.

6. The method of claim 4,
wherein the reference image frame and the correction target image frame comprise a plurality of pixels with each pixel constituting one vertical column in the correction target image frame or the reference image frame, and
wherein in the extracting one or more shift lag comparison target partitions, the predetermined interval is set to a size corresponding to the one pixel.

7. The method of claim 1,
wherein the extracting a maximum correlation partition comprises:
calculating a correlation coefficient between each of the plurality of comparison target partitions and the correction target partition; and
selecting a comparison target partition having a maximum correlation coefficient among the plurality of comparison target partitions as the maximum correlation partition.

8. The method of claim 7, wherein the correction target image frame or the reference image frame is formed by arranging individual pixels, with each pixel constituting one vertical column, side by side in the horizontal direction within the correction target image frame or the reference image frame, and the individual pixels contain multiple pieces of channel-specific signal strength information that constitute one horizontal row within the correction target image frame or the reference image frame.

9. The method of claim 8, wherein in the calculating a correlation coefficient, the correlation coefficient is calculated by comparing all signal strength information included in the comparison target partition with all signal strength information included in the correction target partition.

10. The method of claim 8, wherein in the calculating a correlation coefficient, the correlation coefficient is determined as a correlation coefficient between a vector including all signal strength information included in the comparison target partition and a vector including all signal strength information included in the correction target partition.

11. The method of claim 8, wherein at least some of the pixels comprise signal strength information estimated and determined through interpolation.

12. The method of claim 11, wherein an interpolation rate of the interpolation is determined to correspond to a horizontal angular resolution of the LiDAR device.

13. The method of claim 12, wherein the channel-specific signal strength information is allocated through the interpolation to all available pixels to the correction target image frame or the reference image frame.

14. The method of claim 7, wherein in the calculating a field of view offset, the field of view offset is determined by multiplying the maximum correlation coefficient by a horizontal angular resolution of the LiDAR device.

15. The method of claim 1, further comprising moving the position of the correction target partition by a calculated field of view offset within the correction target image frame.

16. A LiDAR device, comprising:
an optical transmitter configured to transmit laser light;
an optical receiver configured to receive laser light transmitted by the optical transmitter and reflected from the outside;
a scanner that has reflection mirrors on a plurality of surfaces that reflect laser light transmitted by the optical transmitter to the outside or reflect laser light reflected from the outside to the optical receiver and operates so that the plurality of surfaces rotate around an axis; and
a controller configured to detect laser light received by the optical receiver and generate image information,
wherein the controller stores one or more field of view offsets calculated according to the method for correcting an image frame of a LiDAR device according to claim 1.

17. The LiDAR device of claim 16, wherein the controller is configured to generate a plurality of image frames corresponding to the number of surfaces provided with the reflection mirror during one rotation of the scanner, and store the field of view offset for the plurality of image frames.

18. The LiDAR device of claim 17, wherein the field of view offset is allocated, based on an image frame set as the reference image frame among the plurality of image frames, for each of the remaining correction target image frames except for the image frame set as the reference image frame among the plurality of image frames.

19. The LiDAR device of claim 17, wherein the correction target image frame comprises a plurality of partitions extracted throughout the entire correction target image frame without overlapping each other, and the field of view offset is allocated for each of the plurality of partitions.

20. The LiDAR device of claim 17, wherein the controller is configured to output each of the image frames by reflecting the field of view offset when outputting each of the image frames.
